(19) United States
(12) Patent Application Publication
(10) Pub. No.: US 2007/0143123 A1
(43) Pub. Date: Jun. 21, 2007

(54) System, method and service for recording household assets

(75) Inventors: Kenneth R. Goldberg, Coral Springs, FL (US); Bruce Roberson, Coral Springs, FL (US)

Correspondence Address: PATENTS ON DEMAND, P.A., 4581 WESTON ROAD, SUITE 345, WESTON, FL, 33331, US

(73) Assignee: Arkiva, Inc., Coral Springs, FL (US)

(21) Appl. No.: 11/295,408

(22) Filed: Dec. 6, 2005

(51) Int. Cl. G06Q 99/00

(52) U.S. Cl. 705/1

(57) ABSTRACT

An archiving method that includes a step of identifying a residential property. Items contained within the residential property can be categorized. Entries for each of the categorized items can be recorded within a household asset tracking database. Digital images of the residential property can be obtained, where the digital images are images taken of actual items of the residential property. The digital images can be linked to the entries for the items which are shown in the digital pictures. The linked images and entries can be stored in a data store remotely located from the residential property. An authorized user can be provided with searchable access to the entries and linked images of data store.

### BACKGROUND

1. Field of the Invention

The present invention relates to the field of digital recordation and, more particularly, to a system, method, and service for recording household assets.

2. Description of the Related Art

Most homeowners (or apartment renters) are aware that it is advisable to retain a record of household assets, which can be utilized to facilitate recovery in the aftermath of a disaster that affects the home. Few homeowners, however, have such a record. Homeowners that have constructed a household asset record often store the record within their home. The home-stored record can be lost or damaged by one of the disasters for which the record is constructed. Even if a household asset record is not lost, a majority of homeowner-generated records are a haphazard collection of documents, which incompletely record household assets and home property information.

Without proper records, homeowners having their homes and/or home stored assets compromised by hurricane, flood, fire, and theft will suffer. For example, in absence of proper records, insurance provided loss compensation is inadequate to permit full or even reasonably full recovery. Even if compensation is adequate, homeowners without proper records suffer a delay in their compensation at the very time that it is most needed. Further, no compensation is possible for lost items of personal significance, such as family photographs, letters, and other keepsakes.

Conventional technologies have either not contemplated a need for household asset archiving or provide inadequate mechanisms for satisfying this need. For example, a number of file storage and contact management Web sites exist, where a user is granted an amount of personal file space, often for a monthly fee. None of these sites guide a user through an asset recordation process. None of these sites are specifically directed toward asset recordation.

Additionally, a number of image storage Web sites exist that permit a computer user to place pictures within a Web accessible storage space. Most of the digital photograph Web sites are designed to store and/or share family photographs. Most image storage sites are not specifically directed towards asset recordation.

One known exception to this general rule includes a Web site for storing images that specifically advertises that images can be stored for insurance reasons and that stored images can be shared with an insurance company. This site, however, provides little assistance regarding a manner in which assets are to be properly recorded. It fails to prompt users for attributes that define and otherwise valuate assets. It fails to provide agents that can assist a user in making a proper record. It further fails to verify in any manner that an asset record has been adequately made. In other words, other than verbiage stating that users are able to store images for insurance purposes within a remote storage space, this Web site provides no appreciable advantage over a general purpose file storage site or a general purpose image storage site.

Consequently, all known Web based storage sites fail to guide a user though a household asset recordation process. Instead, conventional Web sites provide a blank file storage space. In some, a user can establish their own directory structure using file folders. In others, a user can view stored images through a thumbnail viewer. No database structures exist in any of these conventional Web sites which help a homeowner organize a household asset record. Accordingly, homeowners attempting to use conventional Web based tools seldom construct an adequate record of household assets and are instead provided with a false sense of security. In the aftermath of a disaster, these homeowners often discover to their chagrin that records which they possess are insufficient to ensure rapid and/or full compensation from an insurance company or to reproduce lost items having personal value.

It is unreasonable to believe that if left unassisted that a majority of homeowners will change long held habits and start recording their own home assets. It is even more unreasonable to believe that homeowners will be technically proficient enough to make digital records of these home assets. That is, many homeowners lack either the technical know-how or equipment to make digital records on their own. Even if a homeowner does construct a digital household asset record, it is unreasonable to believe that without assistance a proper record will be constructed.

What is needed is a service, system, and/or methodology that helps homeowners construct and manage a comprehensive archive of household assets. To obtain a comprehensive archive, the homeowner should be assisted by a skilled archiving expert, intelligently prompted by an automated system for information to ensure a complete archive, and/or specifically trained or guided through a household archiving process. No such service, system, or methodology that satisfies this need currently exists.

### SUMMARY OF THE INVENTION

The present invention includes a system, method, and service that records household assets in accordance with an embodiment of the inventive arrangements disclose herein. As used herein, “household assets” can include any item located at a residential property, including one or more buildings or structures standing upon the residential property as well as fixtures and movable items contained within or attached to the buildings or structures. Further, as used herein, a “homeowner” can refer to any individual living at the residential property or working at the residential property.

Using the invention, a homeowner can be guided through an asset recordation process. In one embodiment, this guidance can occur through a household asset recordation software interface. In another embodiment, a human agent skilled in asset recordation can assist a homeowner. This assistance can be provided either though technical assistance or by having an agent travel to a homeowner's property and making a household asset record for the homeowner.

In one embodiment, the household asset record can be verified to ensure correctness and/or sufficiency. For example, a homeowner can be provided with an asset report and itemized asset valuation. This report can prompt a homeowner to make a more complete asset record and/or to challenge an estimated valuation. The asset record can be indexed and recorded within a household asset tracking database. This database can relate asset images, rooms, values, receipts, notes, and other attributes to each other. An interface can be provided to permit a homeowner to access their stored asset information in an interactive and searchable fashion.

The present invention can be implemented in accordance with numerous aspects consistent with material presented herein. For example, one aspect of the present invention can include an archiving method that includes a step of identifying a residential property. Items contained within the residential property can be categorized. Entries for each of the categorized items can be recorded within a residential asset tracking database. Digital images of the residential property can be obtained, where the digital images are images taken of actual items of the residential property. The digital images can be linked to the entries for the items which are shown in the digital pictures. The linked images and entries can be stored in a data store remotely located from the residential property. The data store can include, can be linked to, or can be synchronized with the household asset tracking database. An authorized user can be provided with searchable access to the entries and linked images of data store.

Another aspect of the present invention can include a residential archiving system. The system can include a data gathering component, a digitizing component, a remote data store, and a data retrieval component. The data gathering component can acquire images of a residential property and can contain attributes for assets associated with the residential property. The digitizing component can convert the images and attributes into a digital format. The remote data store can store a digital form of the images and attributes. The stored images and attributes can be indexed relative to each other. The data retrieval component can permit an authorized user to selectively retrieve the images and attributes from the remote data store.

Yet another aspect of the present invention can include a household asset tracking database. The database can include household property records. Each household property record can correspond to a different residential property. Each household property record can be linked to at least one room record. Each household property record can also be linked to multiple asset records.

Each room record can have an associated room designator and at least one room image. The room image can be based upon a photograph taken of a room of a corresponding residential property. Each asset record can have an associated item designator and at least one asset image. The asset image can be based upon a photograph taken of an asset within a corresponding residential property.

Each asset record can be linked to a room record corresponding to a room in which an asset associated with the asset record is located. Information within the resident asset tracking database can be made available to subscribers of a household asset tracking service. Each subscriber can be authorized to access only those records associated with a residential property of that subscriber.

Still another aspect of the present invention can include a property management software interface that includes a user identification and authorization element, an interface data retrieval component, and an item presentation view. The user identification and authorization element can determine a user identifier and a user password. The interface data retrieval component can communicatively link the software interface to a remote data store and can securely retrieve selected records from the remote data store based upon the user identifier and the user password. The item presentation view can present property items and attributes associated with property items.

At least one of the attributes can include an image of the property item. The presented property items and attributes can be based upon records retrieved from the remote data store. The property items and attributes can be associated with a residential property. The user identifier can also be associated with the residential property.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or in any other recording medium. The program can also be provided as a digitally encoded signal conveyed via a carrier wave. The described program can be a single program or can be implemented as multiple subprograms, each of which interact within a single computing device or interact in a distributed fashion across a network space.

The method detailed herein can also be a method performed at least in part by a service agent and/or a machine manipulated by a service agent in response to a service request or performed automatically as part of a household assert recordation service.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a residential archiving system in accordance with an embodiment of the inventive arrangements disclosed herein

FIG. 2 is an information diagram for a household asset data base in accordance with an embodiment of the inventive arrangements disclosed herein.

FIG. 3 shows two Web based interfaces for accessing digitally stored records of the recordation service in accordance with an embodiment of the inventive arrangements disclosed herein

FIG. 4 is a flow chart of a method for archiving household assets in accordance with an embodiment of the inventive arrangements disclosed herein.

FIG. 5 is a flow chart of a method showing a manner in which a service agent can facilitate the archiving of household assets in accordance with an embodiment of the inventive arrangements disclosed herein.

### DETAILED DESCRIPTION OF THE INVENTION

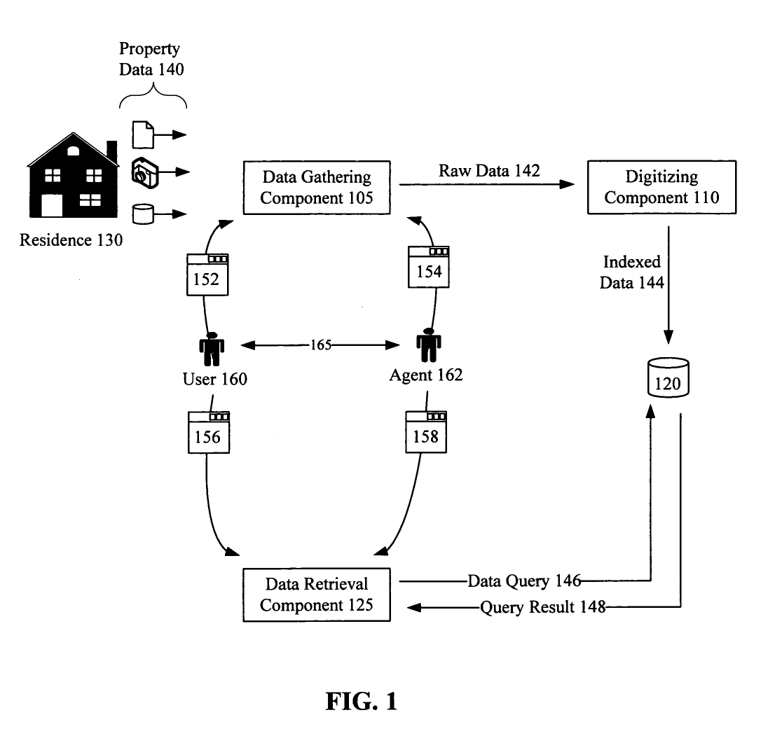

FIG. 1 is a schematic diagram of a residential archiving system 100 in accordance with an embodiment of the inventive arrangements disclosed herein. System 100 can include a data gathering component 105, a digitizing component 110, a data store 120, and/or a data retrieval component 125.

The data gathering component 105 can be configured to acquire images of a residential property 130 and to record attributes for assets associated with the residential property 130. These images and attributes can be collectively referred to as raw data 142. Raw data 142 can include paper documents, physical photographs, physical records, digital information, images, and the like. Raw data 142 can include property data 140 obtained from residence 130 as well as data derived from data 140, agents sent to residence 130, and/or other data sources, such as Internet sources. Additionally, data gathering component 105 can include one or more data gathering interfaces, such as interfaces 152 and/or 154.

The digitizing component 110 can be configured to convert the raw data 142 into a digital format. That is, the digitizing component 110 can convert photographs into digital images, can scan paper documents to generate scanned documents, and can convert documents stored in multiple formats into standardized formats. For example, all documents can be converted to a Rich Text Format (RTF) regardless of their original formatting. In another example, all images can be stored as Joint Photographic Experts Group (JPEG) images, Tagged Image File Format (TIFF) images, and/or Portable Document Format (PDF) files. The digitizing component 110 can index raw data 142 after it has been processed. Thus, the digitizing component 110 can convert raw data 142 into indexed data 144.

The data store 120 can be a storage space remotely located from the residential property in which indexed data 144 is stored. The data store 120 can include a household asset tracking data base. The indexed data 144 can be stored as records within appropriate tables of the household asset tracking database.

For any given residence 130, the indexed data 144 taken together can form a household asset record for the residence 130. A household asset record can include a sufficient quality and quantity of information to ensure a homeowner associated with residence 130 is adequately compensated for insured losses related to residence 130 should a disaster affect residence 130. A disaster can include a hurricane, fire, flood, theft, or any other event which adversely affects residence 130 or assets contained therein.

The data retrieval component 125 can be configured to permit an authorized user to selectively retrieve information from data store 120. The selective retrieval can involve the data retrieval component 125 first submitting a data query 146 to the data store 120. The data query 146 can be a database query, such as a SQL query made to a household asset tracking database linked to data store 120. Query 146 can generate query result 148, which is conveyed to the data retrieval component 125. Data retrieval component 125 can include one or more data retrieval interfaces, such as interfaces 156 and/or 158.

Data store 120 can be physically implemented within any type of hardware including, but not limited to, a magnetic disk, an optical disk, a semiconductor memory, a digitally encoded plastic memory, a holographic memory, or any other recording medium. Data store 120 can include one or more stand-alone storage units as well as one or more storage units formed from a plurality of physical devices, which may be remotely located from one another. Data store 120 can include redundant components, one or more backup mechanisms, and other fault tolerant components to ensure that information is maintained and accessible in the event of a failure of one or more components comprising data store 120.

Interfaces 152, 154, 156, and 158 can each be a voice based software interface, a graphical user interface (GUI), a multi-modal interface, and the like. In one embodiment, one or more of the interfaces 152, 154, 156, and 158 can include a telephony interface. In such an embodiment, the data gathering component 105 and/or the data retrieval component 125 can include an interactive voice response system (IVR), speech processing components, and telephony components. In another embodiment, one or more of interfaces 152, 154, 156, and 158 can include a Web-based interface.

It should be appreciated that presentation interfaces 156 and 158 can be linked to numerous output devices upon which results 148 can be presented. Output devices can include, but are not limited to, display screens, printers, fax machines, audio transceivers, e-mail accounts, and the like.

Component 105, 110, and 125 can each be implemented as machine readable instructions that cause a machine or computing device to perform programmatic actions. Component 105, 110, and/or 125 can each be contained within a single computing device or can be distributed across multiple computing devices. Additionally, each of the components 105, 110, and 125 can be integrated with other ones of the components 105, 110, and/or 125 to form an integrated software system, which is used to create and manage a household asset record for residence 130.

Residence 130 can represent a home, an apartment, and/or a small business that a person can own, rent, or lease. This person is generically referred to herein as a “homeowner.”

The household asset record can include property data 140 for the residence 130. The property data 140 can include photographs taken of the outside or inside of residence 130 or digital images created or derived from photographs of residence 130.

Property data 140 can also include photographs or images of items contained within the residence 130. Property data 140 can include a digital copy of information stored within the residence 130, such as a backup of files contained within a hard drive of a computer located within residence 130. Further, property data 140 can include documents and other paper records contained within residence 130.

Operations performed within system 100 can be initiated by user 160, user 162, or combinations of the two. User 160 can be a homeowner or a user authorized by a homeowner to perform actions for the homeowner. For example, user 160 can be an insurance agent that the homeowner has authorized to access content of data store 120. Different authorized users 160 can be granted different access privileges, such as read, add, update, and delete privileges for content stored in data store 120.

User 162 can include one or more agents of a recordation service that assist user 160 in creating, maintaining, or accessing a household asset record. For example, agent 162 can include an agent that travels to residence 130 and takes pictures of the residence, which are ultimately stored within data store 120. Agent 162 can also include a customer service agent with whom user 160 can communicate 165. For example, agent 162 can provide technical assistance to user 160 who is having trouble entering information through interface 152. In another example, agent 162 can receive a telephone call from user 160, can access a household asset information using interface 158 for user 160, and can provide requested information to user 160.

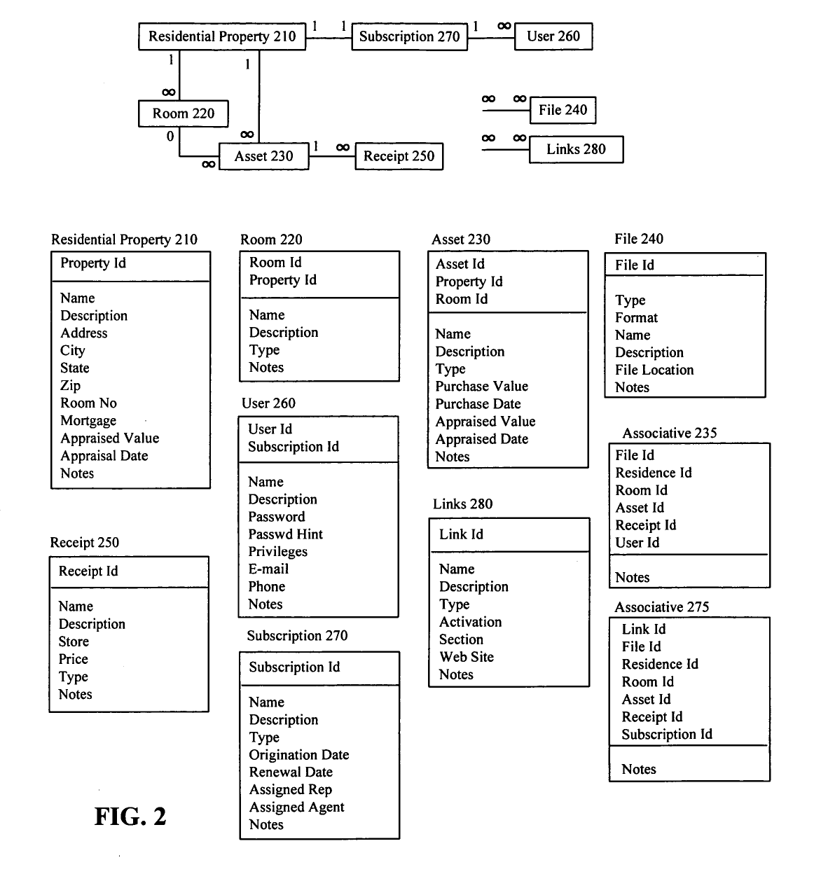

FIG. 2 is an information diagram 200 for a household asset tracking data base in accordance with an embodiment of the inventive arrangements disclosed herein. Diagram 200 is a data model that shows one contemplated arrangement for database tables. Other data models can be constructed based upon or derived from diagram 200 by one of ordinary skill in the art without undue experimentation. By convention, the tables in diagram 200 are normalized in the third normal form (3NF) according to the Bakus-Nauer notation for data modeling. In one embodiment, the data store 120 of FIG. 1 can be organized in the manner detailed in diagram 200.

Diagram 200 includes a multitude of tables, which are related to one another through relational database links. The tables can include a residential property table 210, a room table 220, an asset table 230, a file table 240, a receipt table 250, a user table 260, a subscription table 270, and a links table 280.

Each unique residential property entry stored in the residential property table 210 is associated with one subscription for an archiving service, which is recorded in the subscription table 270. Each subscription entry in the subscription table 270 is associated with one entry in the residential property table 210. In other words, a one-to-one relationship exists between the records in the residential property table 210 and records in the subscription table 270.

Each residential property can have more than one room. Each recorded room can be a room of a particular residential property. Accordingly, each record in the residential property table 210 can be associated with more than one record in the room table 220. Each entry in the room table 220 can be associated with a single entry in the residential property table 210. Accordingly, a one-to-many relationship exists between records in the residential property table 210 and records in the room table 220.

A room of a house can include many assets or recorded items. Additionally, assets not located within a room, such as outdoor assets, need not be associated with a room. Therefore, a zero-to-many relationship exists between the rooms table 220 and the asset table 230. Additionally, a one-to-many relationship exists between the residential property table 210 and the asset table 230. A one-to-many relationship exists between the asset table 230 and the receipt table 250.

Because multiple users can be authorized to access residential records under a subscription, and because each user must be associated with a subscription, a one-to-many relationship exists between the subscription table 270 and the user table 260.

The file table 240 can include a variety of files and file types. File types stored in the file table can include digital images, video clips, scanned documents, and the like. One or more images of an asset can be stored in the file table 240. Similarly, one or more images of a room can be stored in the file table 240. The same image can be an image of a room and can also be an image of an asset within the room. Additionally, one or more scans of a receipt can be stored in the file table 240.

One or more files can be associated with a residential property or a user. Accordingly, a many-to-many relationship exists between the file table 240 and the residential property table 210, between the file table 240 and the room table 220, between the file table and the asset table 230, between the file table 240 and the receipt table 250, and between the file table 240 and the user table 260.

The links table 280 can include Web links to Web sites. A Web link can be provided for an asset, such as a link to a manufacturer's home page or a specification document for an associated asset. Links can also be included for an online banking site that are related to receipts included in the receipt table 250. A link to an architecture Web site or a Web site containing residence blueprints can be linked to a suitable record of the residential property table 210. A different link to residential property tax Web site can be associated with a corresponding record in the residential property table 210. A single Web link can also be associated with multiple records in different tables.

In summary, a many-to-many relationship can exist between the links table 280 and the file table 240, between the links table 280 and the residence table 210, between the links table 280 and the room table 220, between the links table 280 and the asset table 230, between the links table 280 and the receipt table 250, between the links table 280 and the user table 260, and between the links table 280 and the subscription table 270.

Each of the tables in diagram 200 can include many different attributes, which is shown in FIG. 2. The residential property table 210 can include attributes for property name, description, address, city, state, zip code, the number of room in the residence, mortgage loan value of the property, appraised property value, appraisal data, and notes.

Room table 220 can include attributes for a room name, description, type, and notes. Asset table 230 can include attributes for asset name, description, type, purchase value, purchase data, appraised value, appraisal date, and notes. Receipt table 250 can include attributes for receipt name, description, store of purchase, price, type, notes, and purchase date. User table 260 can include attributes for name, description, password, password hint, access privileges, email contact, phone, and notes. Subscription table 270 can include attributes for name, description, subscription type, origination date, renewal date, assigned representative, assigned agent, and notes.

File table 240 can include attributes for file type, file format, name, description, file location, and notes. An associative table 235 can be used to associate records in the file table 240 to records in tables 210, 220, 230, 250, and 260. Links table 280 can include attributes for http address, name, description, link type, and notes. An associative table 275 can be used to associate records in the links table 280 with records in tables 210, 220, 230, 240, 250, and 270.

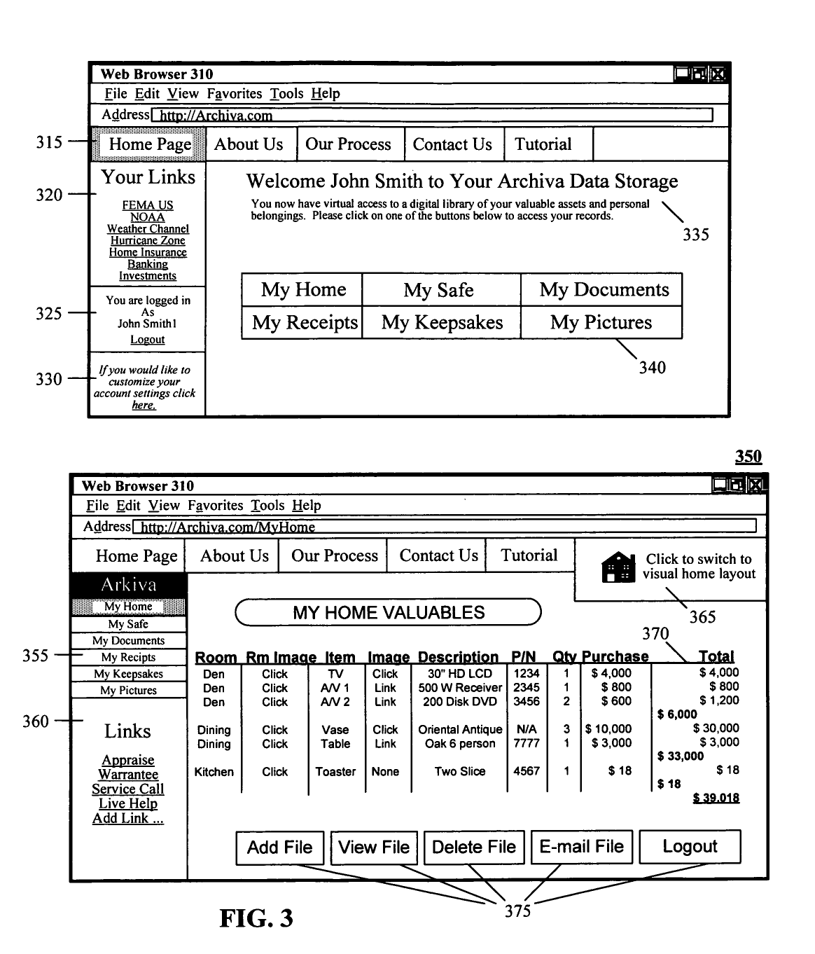

FIG. 3 shows two Web based interfaces, graphical user interface (GUI) 300 and GUI 350, for accessing digitally stored records of the recordation service in accordance with an embodiment of the inventive arrangements disclosed herein. GUI 300 and GUI 350 can be Web based interfaces accessible from within Web browser 310. In one embodiment, GUI 300 and GUI 350 can be interfaces used by system 100. In another embodiment, GUI 300 and GUI 350 can be a front end software interface for a database backend, where the database is organized in accordance with diagram 200.

GUI 300 can be a home page for a Web site that provides an interface accessible by customers to records stored using a recordation service. GUI 300 can include a navigation section 315, a link section 320, a login section 325, a configuration section 330, a welcome section 335, and a view selection 340 section.

Navigation buttons 315 can be used to accessing different portions of the Web site. As illustrated, navigation buttons 315 can include buttons for a home page, an about page, a process description, a contact page, and a tutorial.

Links section 320 can contain links to relevant sites which may or may not be partnered with the recordation service. Links can be automatically selected based upon the purpose for which records are stored. If the primary purpose that records are accessed by GUI 300 is for disaster recovery, links can be provided to a weather site, an insurance site, a banking site, and the like. It should be appreciated that links can be associated with the links table 280 and can be dynamically updated depending upon other information that is appearing within GUI 300.

For example, if a John Smith has logged into GUI 300, records contained within links table 280 that are associated with user table 260 (where user name equals “John Smith”) can be presented within links section 320. Alternatively, links associated with a property record of the residential property table 210 for which “John Smith” is granted access can be presented within links section 320.

Login section 325 can permit a user to provide a user name and password to login. Once logged in, an option can be provided to permit a user to logout. Section 330 can permit a user to customize the look and feel of GUI 300 and any other screen associated with the recordation Web site. Welcome section 335 can provide a brief welcome message, a service overview, and other such general information.

View section 340 can permit a user to view their stored documents in a number of different manners. Content provided within the different views of view section 340 can be redundant with other views. For example, similar content can appear in the “my home” view as in the “my safe view”, which is organized in a different manner. The views can permit a user to quickly locate desired information in an intuitive manner.

GUI 350 illustrates one contemplated arrangement for the “my home” view. GUI 350 can list a plurality of items in an item table 370 organized by the room of a house in which the items appear. The items can appear as rows in table 370. Table 370 can also include multiple columns, each containing an attribute for the item. Columns of table 370 can include, but are not limited to, a room column, a room image, an item column, an item image, a description column, a part number column, a quantity column, a purchase price column, and a total price column.

When an image cell is selected in table 370, an appropriate image for that cell can be presented. For example, when room image cell having a row heading of Den is selected, one or more pictures of the Den of a home can be presented. In another example, when an item image cell is selected, an image of that item, or an image of a room where the item is visible can be presented. One or more record buttons 375 can permit records to be added, viewed, deleted, emailed, and the like.

In one embodiment, an alternative home view can be provided, such as a visual home view 365. In the visual home view 365, a layout of a home can be presented and the user can zoom in on different rooms and/or items by selecting them within this layout. For example, the layout can permit a user to virtually walk through the various rooms in a house and to pick up and examine items in the rooms. Stored records can be retrieved for the items selected with the virtual rooms responsive to user selections.

GUI 350 can also include buttons 355 to other item views, such as the “my safe” view, the “my documents” view, the “my receipts” view, the “my keepsakes” view, and the “my pictures” view. A Web links section 360 customized for GUI 350 can also be presented. Links in section 360 can be dynamically adjusted for a home and/or for items currently presented in table 370.

It should be appreciated that GUI 300 and 350 are provided to demonstrate concepts described for an embodiment of the inventive arrangements disclosed herein. GUI 300 and GUI 350 are not intended to constrain the scope of the invention to a particular contemplated expression. Derivatives of GUI 300 and 350 including different interface elements, arrangements, layouts, and the like are contemplated herein. Further, the invention is not limited to using graphical interfaces. Voice interfaces, multimodal interfaces, telephony interfaces, three dimensional interfaces, and the like are also contemplated.

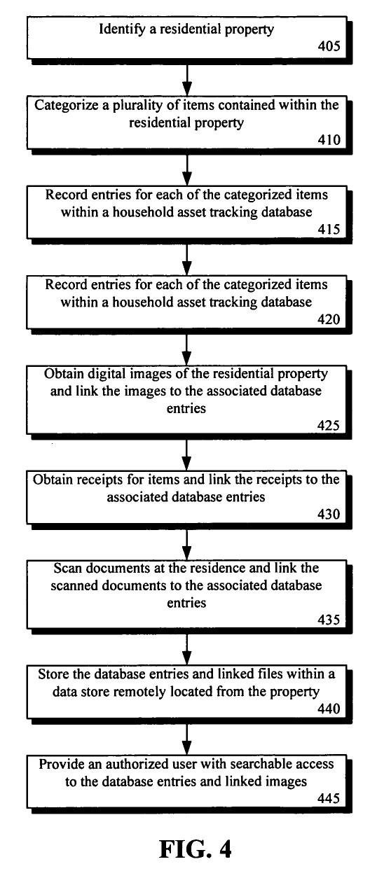

FIG. 4 is a flow chart of a method 400 for archiving household assets in accordance with an embodiment of the inventive arrangements disclosed herein. In one embodiment, method 400 can be performed in the context of system 100. In another embodiment, method 400 can utilize a database constructed in accordance with diagram 200. In still another embodiment, the searchable access provided by step 445 of method 400 can be performed using GUI 300 and/or GUI 350. It should be appreciated, however, that method 400 can be performed in the context of any household asset management system using any of a variety of data storage methodologies, interfaces, and technologies.

Method 400 can begin in step 405, where a residential property can be identified. In step 410, a plurality of items within property can be categorized. In step 415, record entries for each of the categorized items can be placed within a household asset tracking database.

In step 425, digital images of the residential property can be obtained. These images can be actual images taken on site. In one embodiment, an agent of a recordation service can travel to the property and take the photographs. In another embodiment, a software program or live service agent can guide a home owner through the picture taking process to ensure images are obtained of significant household assets. Photographs can be converted into digital images as necessary in step 425. Once all digital images are obtained, the images can be linked to corresponding database entries.

In step 430, receipts for items purchased for the residence can be obtained. The receipts can be scanned into a digital form if necessary, where the scanning can be performed by an agent of a recordation service or by a homeowner. The receipts can be associated with database entries.

In step 435, paper documents, keepsakes, and the like can be converted into a digital format. This converting can be performed by either an agent of a recordation service or by a homeowner. The converted documents can be linked to corresponding database records. Similarly, copies of computer records or digitally stored media can be made from computing and storage device on site and stored within a data store after being linked to corresponding database records.

In step 440, database entries and linked files can be stored in a data storage area remotely located from the residential property from which the records were obtained. In step 445, one or more authorized users can be provided with searchable access to the database and the linked images contained therein. For example, an authorized user can access a Web site or IVR that is linked to the database.

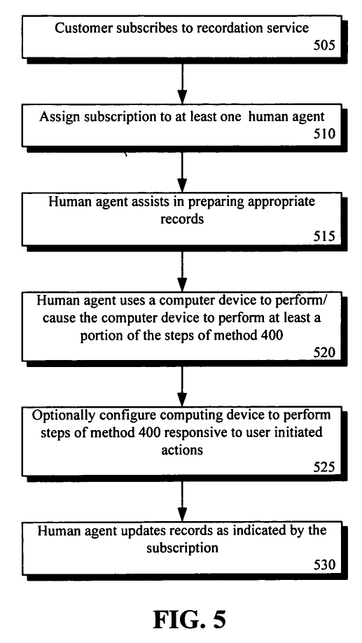

FIG. 5 is a flow chart of a method 500 showing a manner in which a service agent can facilitate the archiving of household assets in accordance with an embodiment of the inventive arrangements disclosed herein. For example, the service agent can perform one or more steps of method 400.

Method 500 can begin in step 505, when a customer, such as a homeowner, subscribes to a recordation service. In step 510, a human agent can be selected by the service agency to assist the customer. In step 515, the human agent can interact with the subscriber to obtain asset information. In one embodiment, the human agent can train the subscriber to utilize software or a Web interface provided by the recordation service. The subscriber can provide necessary information using based upon prompts from this interface.

In step 520, the human agent can use one or more computing devices to perform or to cause the computer device to perform the steps of method 500 in accordance with the customer's subscription plan. For example, the subscription plan can entitle the customer to have the agent travel to the customer's property and to take pictures of the property using a digital camera. In another example, the subscription plan can entitle to customer to mail paper documents and/or photographs to the agent. The agent can scan or otherwise digitally convert the provided documents and photographs, can enter the digital copies within a database, and can return the paper copies of the documents to the customer. Appreciably, the one or more computing devices used by the human agent can include the customer's computer, a mobile computing device used by the human agent, a networked computing device, a digital camera, a scanner, conversion software, a database application, and combinations thereof.

In optional step 525, the human agent can configure the customer's computer or computing devices in a manner that the customer or clients of the customer can perform one or more steps of method 500 in the future. This configuring of the computer can include providing the customer with training in how to utilize the equipment. For example, the human agent can install household asset tracking software on the client's computer, can install drivers and connections for a digital camera or scanner, and can show the customer how to use the equipment. In step 530, the human agent can complete the service activities.

It should be appreciated that under certain subscription plans (a premium plan), the customer can be entitled to contact the service agent to obtain additional help without any additional change. Under other service plans, training provided by a service agent, configuration assistance, on-site support, and the like can result in additional charges. It should be noted that while the human agent may physically travel to a location to configure a client system, physical travel may be unnecessary. For example, the human agent can use a software application to remotely configure a client's computer and/or to provide live, Web based assistance.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

What is claimed is:

1. An archiving method comprising:
identifying a residential property;
categorizing a plurality of items contained within the residential property;
recording entries for each of the categorized items within a household asset tracking database;
obtaining digital images of the residential property, the digital images being images taken of actual items of the residential property;
linking the digital images to the entries for the items which are shown in the digital pictures;
storing the linked images and the entries in a data store remotely located from said residential property; and
providing an authorized user with searchable access to the entries and linked images of data store.

2. The method of claim 1, said method further comprising:
said authorized user subscribing to a household asset recordation service, wherein said categorizing, recording, obtaining, linking, storing, and providing steps are performed as part of the household asset recordation service or are performed by a software program provided by the household asset recordation service.

3. The method of claim 2, wherein at least one of the categorizing, recording, obtaining, linking, and storing steps is performed by a human agent of the household asset recordation service.

4. The method of claim 1, said method further comprising:
sending an agent to the residential property to photograph the residential property, wherein the linked images are generated from photographs taken by the agent.

5. The method of claim 1, said method further comprising:
identifying a plurality of paper documents contained within the residential property;
scanning the paper documents to generate digital copies of the paper documents;
linking the digital copies to the entries;
storing the linked copies in the data store; and
providing the authorized user with searchable access to the linked copies.

6. The method of claim 5, further comprising:
sending an agent to the residential property, wherein the scanning step is performed at the residential property by the agent.

7. The method of claim 1, wherein each of the entries includes an attribute for a room of the residential property where each item is located.

8. The method of claim 1, wherein the providing step further comprises:
providing a Web interface for accessing the database, wherein said Web interface includes a view for searching the categorized items by a room of the residential property in which the categorized items are located.

9. The method of claim 8, further comprising:
within the Web interface, visually providing a schematic for an interior of the residential property, the schematic separately illustrating rooms of the residential property, wherein items located within the illustrated rooms are graphically selectable by a user, wherein a selection of an item results in corresponding textual information for the selected item obtained from the household asset tracking database being responsively displayed within the Web interface.

10. The method of claim 1, wherein the providing step further comprises:
providing a telephony voice interface for accessing the database.

11. The method of claim 1, further comprising:
generating a report of the household items;
conveying the report to an owner of the residential property; and
receiving approval of the report from the owner before performing at least one of the storing step and providing step.

12. The method of claim 1, wherein said method is part of a disaster recovery method that is utilized to protect the residential property and assets contained therein in an event of a disaster, said method further comprising:
valuating the categorized items before an occurrence of a disaster.

13. The method of claim 12, further comprising the step of:
an owner of the residential property verifying an accuracy of the valuating step before an occurrence of a disaster.

14. The method of claim 12, further comprising the step of:
an insurer of the residential property verifying an accuracy of the valuating step before an occurrence of a disaster, wherein the insurer utilizes the verified values of the categorized items to provide compensation for the categorized items when a disaster affecting the residential property occurs.

15. The method of claim 1, wherein the steps of claim 1 are performed by at least one of a service agent and a computing device manipulated by the service agent, the steps being performed in response to a service request.

16. The method of claim 1, wherein said steps of claim 1 are performed by at least one machine in accordance with at least one computer program having a plurality of code sections that are executable by the at least one machine.

17. A residential archiving system comprising:
a data gathering component configured to acquire images of a residential property and to record attributes for assets associated with the residential property;
a digitizing component configured to convert the images and attributes into a digital format;
a remote data store remotely located from the residential property configured to store a digital form of the images and attributes, wherein the stored images and attributes are indexed relative to each other; and
a data retrieval component configured to permit an authorized user to selectively retrieve the images and attributes from the remote data store.

18. The system of claim 17, wherein a client associated with the residential property subscribes to a household asset recordation service, wherein an agent for the household asset recordation service travels to the residential property and takes photographs, wherein said acquired images include said photographs.

19. The system of claim 18, wherein the client provides an encryption key unknown by the agent, wherein the agent utilizes the encryption key to secure digital content associated with the residential property, and wherein the encryption key is needed to decrypt data retrieved from the remote data store.

20. The system of claim 17, wherein said data gathering component is further configured to copy digital information stored within at least one of a computer and a storage medium which is located within the residential property, wherein at least one of said data gathering component and said digitizing component is further configured to scan paper documents into a digital format, wherein said copied digital information and the scanned documents are stored within the remote data store and are accessible via the data retrieval component.

21. The system of claim 17, wherein the recorded attributes for an asset comprise at least three attributes selected from a group consisting of a purchase value, a purchase date, an appraised value, an appraised date, and a room in which the item is located.

22. The system of claim 17, wherein each asset is configured to be associated with a plurality of stored images, said images including at least one pre disaster image and at least one post disaster image.

23. The system of claim 17, wherein said data retrieval component includes a voice-based user interface accessible via a telephony connection.

24. The system of claim 17, wherein the data retrieval component includes an automated component configured to fax stored images and database information to an authorized user upon request.

25. The system of claim 17, wherein the data retrieval component includes an automated component configured to email stored images and database information to an authorized user upon request.

26. The system of claim 17, wherein the data retrieval component includes a Web interface for accessing the remote data store, wherein said Web interface includes a view for searching images and attributes assets by a room of the residential property in which the assets are located.

27. The system of claim 26, wherein the Web interface includes a schematic for an interior of the residential property, the schematic separately illustrating rooms of the residential property.

28. The system of claim 26, wherein items located within the rooms are graphically selectable by a user, wherein a selection of an item results in corresponding textual information for the selected item obtained from the household asset tracking database being responsively displayed within the Web interface.

29. The system of claim 26, wherein the Web interface includes a user navigatable three dimensional interface, wherein a user is able to select items within the three dimensional interface to obtain related information from the household asset tracking database.

30. A household asset tracking database comprising:
a plurality of household property records, wherein each household property record corresponds to a different residential property, wherein each household property record is linked to a plurality of room records, and wherein each household property record is linked to a plurality of asset records;
each room record having an associated room designator and at least one room image, wherein each room image is a based upon a photograph taken of a room of a corresponding residential property; and
each asset record having an associated item designator and at least one asset image, wherein each asset image is a based upon a photograph taken of an asset within a corresponding residential property, wherein each asset record is linked to a room record corresponding to a room in which an asset associated with the asset record is located, wherein information within the resident asset tracking database is made available to subscribers of a household asset tracking service, wherein each subscriber is authorized to access only those records associated with a residential property of that subscriber.

31. The asset tracking database of claim 30, wherein said resident asset tracking database is accessible by subscribers though a Web browser, wherein an interface of the Web browser presents records on a room by room basis, wherein a subscriber is able to select a room using the interface and be responsively provided with a listing of recorded assets located within the selected room and be responsively provided with at least one image of the selected room.

32. The asset tracking database of claim 30, wherein at least one agent of the household asset tracking service travels to at least a portion of the different residential properties and takes photographs, wherein the agent taken photographs are used to generate at least a portion of the room images and the asset images.

33. A property management software interface comprising:
a user identification and authorization element for determining a user identifier and a user password;
an interface data retrieval component, which communicatively links the software interface to a remote data store and securely retrieves selected records from the remote data store based upon the user identifier and the user password; and
an item presentation view that presents a plurality of property items and attributes associated with property items, wherein at least one of the attributes includes an image of the property item, wherein the presented property items and attributes are based upon the retrieved records from the remote data store, wherein the property items and attributes are associated with a residential property to which the user identifier is associated.

34. The software interface of claim 33, wherein the interface includes a telephony interface to an interactive voice response system communicatively linked to the remote data store.

35. The software interface of claim 33, wherein the interface includes a user interface to an automated system communicatively linked to the remote data store, wherein a user of the interface is able to select stored records of the remote data store, and wherein images and attributes associated with the selected records are responsively faxed to a user specified fax machine or is responsively emailed to a user specified email address.

36. The software interface of claim 33, wherein the interface includes a Web interface for accessing the remote data store, wherein said Web interface includes a view for searching images and attributes assets by a room of the residential property in which the assets are located.

37. The system of claim 36, wherein the Web interface includes a schematic for an interior of the residential property, the schematic separately illustrating rooms of the residential property.

38. The system of claim 36, wherein items located within the illustrated rooms are graphically selectable by a user, wherein a selection of an illustrated item results in corresponding textual information for the selected item obtained from the remote data store being responsively displayed within the Web interface.

39. The system of claim 36, wherein the Web interface includes a user navigatable three dimensional interface, wherein a user is able to select items within the three dimensional interface to obtain information about selected items from the remote data store.

40. The software interface of claim 33, wherein the remote data store includes a resident asset tracking database maintained by a household asset management service, wherein the property management interface is a user interface to an automated system of the asset management service though which homeowners associated with the residential property that subscribe to the household asset management service are able to access.

41. The software interface of claim 40, wherein an agent of the household asset management service performs a recordation action related to the residential property and the records stored within the remote data store, said recordation action being selected from a group of actions including at least one of a photographing action, a scanning action, a categorizing action, and a digitizing action.

42. The software interface of claim 41, wherein said recordation action includes the photographing action, wherein in the photographing action the agent travels to the residential property and takes pictures upon which at least a portion of the images are based.

43. The software interface of claim 41, wherein said recordation action includes the scanning action, wherein in the scanning action the agent travels to the residential property and scans paper documents to generate digital documents that are stored in the remote data store and that are linked to the property items.

44. The software interface of claim 41, wherein said recordation action includes the categorizing action, wherein in the categorizing action the agent takes raw information about the residential property, categorizes raw information according to categories established by the household asset management service, and inputs the categorized information into the remote data store.

45. The software interface of claim 41, wherein said recordation action includes the digitizing action, wherein in the digitizing action the agent receives paper-based documents and photographs associated with the residential property, generates a digital version of each of the paper-based documents, and stores the digital versions in the remote data store.
